(19) United States
(12) Patent Application Publication
(10) Pub. No.: US 2014/0011107 A1
(43) Pub. Date: Jan. 9, 2014

(54) METHOD FOR OPERATING A FUEL CELL

(71) Applicants: Xavier Glipa, Verneuil Sur Seine (FR); Jean Francois Ranjard, Versailles (FR); Eric Pinton, Echirolles (FR); Jean-Philippe Poirot Crouvezier, Saint Georges De Commiers (FR); Sylvie Begot, Chaux (FR); Fabien Harel, Giromagny (FR); Jean-Marc Le Canut, Belfort (FR)

(72) Inventors: Xavier Glipa, Verneuil Sur Seine (FR); Jean Francois Ranjard, Versailles (FR); Eric Pinton, Echirolles (FR); Jean-Philippe Poirot Crouvezier, Saint Georges De Commiers (FR); Sylvie Begot, Chaux (FR); Fabien Harel, Giromagny (FR); Jean-Marc Le Canut, Belfort (FR)

(73) Assignees: COMMISSARIAT A L'ENERGIE ATOMIQUE ET AUX ENERGIES ALTERNATIVES, Paris (FR); PEUGOT CITROEN AUTOMOBILES SA, Velizy Villacoublay (FR)

(21) Appl. No.: 14/006,287

(22) PCT Filed: Mar. 7, 2012
(86) PCT No.: PCT/FR12/50474

§ 371 Date: Sep. 19, 2013

(30) Foreign Application Priority Data
Mar. 21, 2011 (FR) 1152320

(51) Int. Cl. H01M 8/04

(52) U.S. Cl. CPC H01M 8/0432
USPC 429/429

(57) ABSTRACT

The invention relates to a method for operating a fuel cell (2), which is to be implemented by means of a control computer (10) that drives the level of current generated by the cells of the fuel cell, said fuel cell including a means for tracking the temperature of the cells, said method being characterized in that it comprises the following steps: when starting the operation of the fuel cell, if the temperature of the cells is at a sufficiently low level, particularly less than 0° C., driving a series of cycles of current intervals including, alternately for each cycle, a low non-zero current (Imin), and then a current interval comprising raising and lowering the strength of the current at programmed speeds.

### CROSS-REFERENCE TO RELATED APPLICATIONS

The present application is the National Stage under 35 U.S.C. §371 of International App. No. PCT/FR2012/050474, filed Mar. 7, 2012, which in turn claims priority from French App. No. 1152320 filed on Mar. 21, 2011 for which the contents (text, drawings and claims) are incorporated herein by reference.

### BACKGROUND

This invention relates to a process for operating a fuel cell to generate electricity; it also relates to an electric generator and an automotive vehicle comprising a fuel cell implementing this method.

Fuel cells currently are developed in particular to equip vehicles as a replacement for internal combustion engines. By generating electricity used by an electric traction unit, fuel cells enable achieving better energy efficiency with respect to internal combustion engines.

Fuel cells generally include a stack of basic cells that comprise two electrodes separated by an electrolyte and two conducting plates that bring the reagents to the electrodes by internal channels. The electrochemical reactions that take place upon contacting the electrodes generate an electric current and produce water, while releasing heat energy that warms the various components.

To operate correctly, the fuel cells must be at a certain temperature range, according to the type of cell, between 20 and 800° C. The heat released by the start of the reactions when the fuel cell is cold first serves to heat the cells to bring them to the desired operating temperature.

To homogenize and regulate the temperature of the fuel cells, the fuel cells generally comprise a temperature regulating system that uses a heat transfer liquid or medium which is circulated by a pump to come into contact with these cells to extract heat, and to dissipate them subsequently in a heat exchanger through an ambient air exchange.

A problem that occurs in the case of starting the fuel cell at low temperatures, e.g., less than 0° C., is that the water produced by the electrochemical reaction runs the risk of freezing as long as this temperature is below this 0° C. threshold. Then, the fuel cell can no longer operate properly and even runs the risk of being damaged.

To remedy this problem, a known operating method, presented among others by US-A1-2005/0238934, drives, when the temperature is sufficiently low, current intervals forming impulses, comprising very rapid rises and drops, by starting from a zero current level to arrive at a high level, so as to punctually obtain a good generated thermal power output ratio, in comparison with the volume of water produced. These current impulses thus enable heating the cells of the fuel cell progressively.

However, a problem that occurs with this operating method is that the establishment of such current impulses comprising a zero current followed by a strong dynamic intensity, causes accelerated aging of the fuel cells, namely by corrosion of the carbon contained in these cells.

### SUMMARY

This invention is aimed at avoiding these inconveniences of the prior art and to propose an operating method that causes rapid heating of the fuel cell, while preserving the lifespan of the cells.

For that purpose, a method for operating a fuel cell is disclosed which is implemented by a control computer that drives the level of current generated by the cells of the fuel cell, with the fuel cell including a means for tracking the temperature of the cells. The method includes the following steps during a startup of the fuel cells if the temperature of the cells is at a sufficiently low level, i.e., approaching or lower than 0° C.: driving a series of cycles of current intervals (40) comprising for each cycle alternately a low non-zero current, and then a current interval comprising scheduled speeds of raising and lowering the strength of the current.

By a temperature close to 0° C. is understood to be a temperature at which, or taking into account uncertainties that may be present for the temperature of the cells, it is estimated that there is indeed a risk of freezing. Therefore, a high threshold at 3° C. can be set.

An advantage of this operating method is that one can obtain quick heating with low water production due to the driven current intervals, as well as a protection of the cells while avoiding a zero current operation and by managing the rising and lowering transients of these intervals.

The operating method according to the invention can also include one or several of the following features which can be combined among each other.

Advantageously, the low current is substantially constant.

Advantageously, the interval includes a holding at a maximum intensity, which is substantially constant.

Advantageously, the maximum intensity corresponds to a value higher than or equal to the intensity value for which the electric power produced is at a maximum.

Advantageously, the programmed speed for raising the strength of the current for the interval, falls between 0.1 and 10 A/cm²/sec, without the voltage of a cell dropping below 0.3 V.

According to an embodiment, the programmed speed of lowering the current strength for the interval, gives the quickest descent possible.

Advantageously, the average duration of the current interval, between the beginning of raising the strength and end of lowering this strength, is between 5 and 50% of the total period of a cycle.

Advantageously, the total duration of a cycle, is between 10 and 200 seconds.

Advantageously, the fuel cell that implements the operating method comprising any of the aforementioned features includes a voltage measurement sensor at the terminals of the cells, and a sensor for measuring the intensity of the current output or current delivered.

The invention also relates to an electric generator with a fuel cell driven by a control method comprising one of the abovementioned features.

In addition the invention also relates to an electric vehicle with a fuel cell that delivers an electric current used for traction; this cell is driven by a control method comprising any of the abovementioned features.

### DESCRIPTION OF THE FIGURES

The invention will be better understood and other features and benefits will appear more clearly when reading the description below given as an example and being non-limiting, referenced against the attached drawings where:

FIG. 1 is a general diagram of a system comprising a fuel cell;

FIG. 2 is a graph showing changes in the electric voltage at the terminals of the cells as well as of the thermal and electric power outputs generated, on the basis of the intensity of the delivered current;

FIG. 3 is a diagram showing an example of a fuel cell, as a function of time, heating of the cells with current impulses driven by an operating method according to the prior art; and

FIG. 4 shows current intervals driven by an operating method according to the invention.

### DETAILED DESCRIPTION

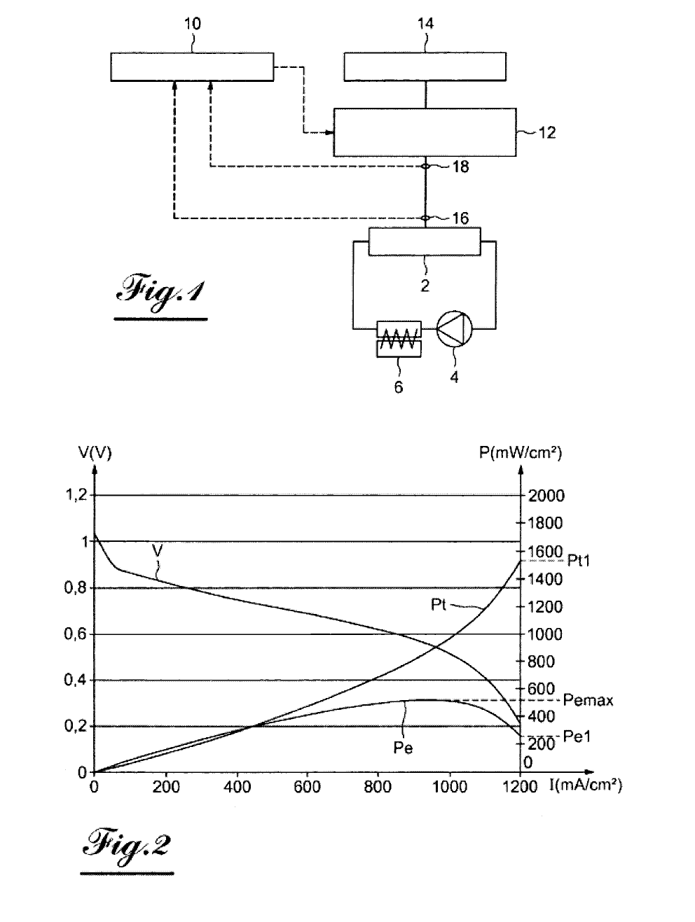

FIG. 1 shows a fuel cell 2 comprising a series of cells traversed by a heat transfer fluid or medium of a cooling system that ensures the heat management of this cell, comprising a pump 4 and a heat exchanger 6 to cool this fluid by exchanging calories/heat with ambient air.

A control computer 10 controls the fuel cell 2, and in particular, the strength of the current delivered in a power converter 12, which feeds a charging device 14 comprising an electric traction unit in the event of this cell being installed in a vehicle.

The electric conductor between fuel cell 2 and the power converter 12 comprises a voltage measuring sensor 16 at the cell terminals, as well as a sensor for measuring the intensity of the delivered current 18. This information is transmitted to the control computer 10 which uses them for control.

On the basis of current strength I delivered by fuel cell 2, expressed as mA/cm², FIG. 2 shows voltage V at the terminals of a cell expressed in Volt V, as well as the electric power Pe and the thermal power Pt by unit of surface delivered by this cell, which are expressed as mW/cm².

It is noted that one obtains, first of all, an intensity of about 600 mA/cm², a regular increase of electric power Pe which is substantially equal to thermal power Pt, then, a ceiling of electric power Pe at a maximum value Pemax for a strength of about 900 mA/cm², which is accompanied by a stronger increase of thermal power Pt, and finally up to the maximum strength of 1200 mA/cm², a drop of this electric power Pe which is accompanied by a strong rise in thermal power Pt.

At the maximum strength of 1200 mA/cm², thermal strength Pt1 is 1500 mW/cm² for an electric power Pe1 of 250 mW/cm², which gives a ratio of approximately 6.

In this last case, one obtains at the same time a strong generation of thermal energy, and a weak electric power production, and consequently water resulting from the electrochemical reaction. This is the case of operation that gives the best ratio for heating the cells as quickly as possible, while minimizing the production of water which may run the risk after saturation of the electrolyte, to freeze as long as the temperature is below 0° C.

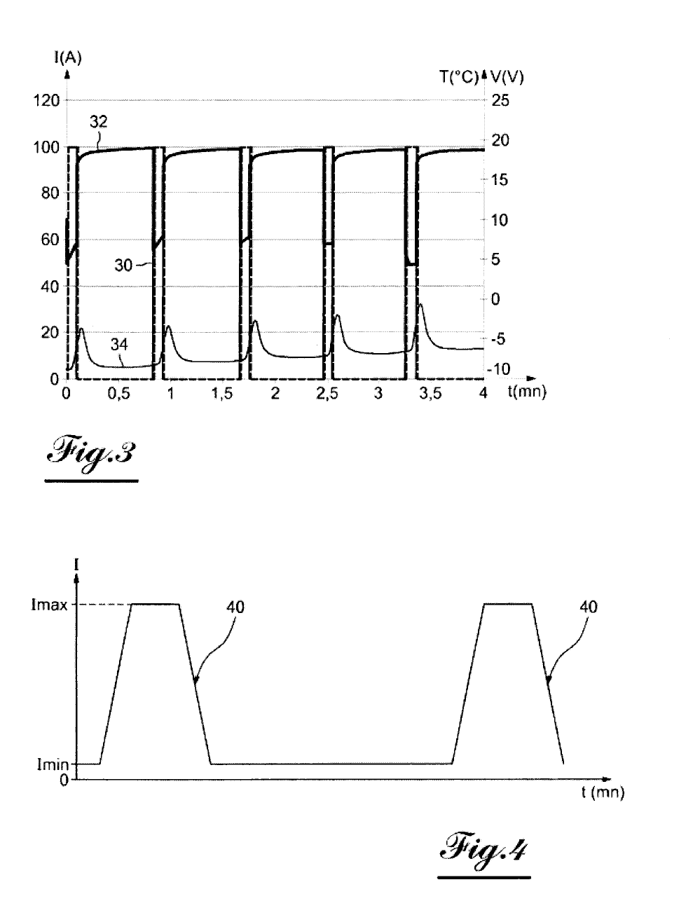

On the basis of time, for an example of a fuel cell comprising a stack of 19 cells of 220 cm² of active surface area, from an initial temperature of −10° C., FIG. 3 shows heating the cells with current impulses driven by a method of operation according to the prior art.

The fuel cell is cooled by a heat transfer fluid or medium of the ethylene-glycol type, comprising a volume of 5.5 liter/minute.

The method according to the invention is applied in the event that a temperature probe, not shown, detects a cell temperature below 0° C., with a risk of freezing the water produced by the reaction.

The method implemented by the control computer 10, then drives the fuel cell 2 to obtain current impulse cycles 30, by requesting from a zero current I, an instantaneous rise in current to a maximum of 100 A, which is maintained for a duration of 10% of the cycle time, then an instantaneous drop of this strength. The cycle is reproduced in this fashion every 50 seconds.

It is noted then that the voltage of the stack of cells shown by curve 32, which is about 19 V when the cell does not deliver current, drops to less than 7 V during the current impulse.

It is also noted that the temperature of the heat transfer fluid presented by curve 34 rises strongly by about 4° C. for each current impulse, then drops again to a level a bit higher than that of the preceding cycle by diffusing its temperature to the stack of cells. Overall, temperature 34 of the heat transfer fluid, and as such of the cells, has progressed regularly by about 3° C. after five cycles of current impulse.

As such, a rapid heating of the fuel cell is achieved with little water production, which prevents a water saturation of the electrolyte and consequently prevents a risk of freezing of this water, before the temperature of the cells reach 0° C.

However, one problem that occurs with this type of driving by current impulses, is that cell aging is greater due to the operation with a zero current, and sudden variations of current with each impulse.

FIG. 4 presents series of interval cycles 40 driven by the present method. The method comprises, for each cycle, a weak (or low) non-zero current Imin which is substantially constant, then a current interval 40 comprising a rise in strength, the speed of which is programmed by this method, then maintenance at the maximum strength Imax, and finally a programmed drop towards minimum strength Imin.

The weak current Imin is calculated so that the average voltage of the cells is maintained at about 0.8 V, which represents a compromise between, on the one hand, a weak current density with reduced water production, and on the other hand, a limitation of aging due to carbon corrosion.

Advantageously, the speed of the rise in strength of the current is between 0.1 and 10 A/cm²/sec, without the voltage of a cell dropping below 0.3 V. The programmed speed of the drop in strength preferably gives the fastest possible drop.

In general, the rise and drop times are compromises between the objectives of the lifespan of the cell that requires long time periods, and of the position of operating points that requires short time periods to achieve these desired points rapidly.

The duration of an interval between the start of the rise in strength and the end of the drop in strength, is preferably between 5 and 50% of the total period of a cycle, which involves a duration between 10 and 200 seconds.

As such, a heating of the cells is achieved that permits optimizing at the same time the heating speed, the limitation of water production and the lifespan of the cells.

In general, the method can permit heating the fuel cell , autonomously, avoiding the installation of an outside auxiliary heating system, or by reducing the power of this auxiliary heating system if installed, and by accelerating the rise in temperature.

In addition, this method implemented by generally existing means in the fuel cell, is economical to make.

1. A method for operating a fuel cell, implemented by means of a control computer that drives the level of current generated by the cells of the fuel cell, said fuel cell including a means for monitoring the temperature of the cells, wherein the method comprises the following steps when starting the operation of the fuel cell if the temperature of the cells is close to or below 0° C., driving a series of cycles of current intervals including, alternately for each cycle, a low non-zero current (Imin) and then a current interval comprising raising and lowering the intensity of the current at programmed speeds.

2. The method of operation according to claim 1, wherein the low non-zero current (Imin) is substantially constant.

3. The method of operation according to claim 1, wherein the interval comprises a maintenance at a maximum strength (Imax) which is substantially constant.

4. The method of operation according to claim 3, wherein the maximum strength (Imax) is higher than or equal to the strength value for which the electric power (Pe) produced is at a maximum.

5. The method of operation according to claim 1, wherein the programmed speed of raising the strength of the current for the interval is between 0.1 and 10 A/cm²/sec, without the voltage of a cell falling below 0.3 V.

6. The method of operation according to claim 1, wherein the programmed speed of the drop in strength of the current for the interval gives the fastest possible drop.

7. The method of operation according to claim 1, wherein the average duration of the current interval between the start of the rise in strength and the end of the drop in strength, is between 5 and 50% of the total period of a cycle.

8. The method of operation according to claim 1, wherein the total duration of a cycle is between 10 and 200 seconds.

9. A fuel cell implementing a method of operation according to claim 1, wherein the fuel cell includes a voltage measuring sensor at the terminals of the cells, and a sensor for measuring the intensity of the current delivered.

10. An electric generator having a fuel cell driven by a control method according to claim 1.

11. An electric vehicle comprising a fuel cell delivering an electric current used for traction, wherein said fuel cell is driven by a method of control according to claim 1.
